(19) United States
(12) Patent Application Publication
(10) Pub. No.: US 2007/0067960 A1
(43) Pub. Date: Mar. 29, 2007

(54) Umbrella handle (I)

(76) Inventors: Youth Lee, Taipei City (TW); Jung Chien Tsai, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/237,927

(22) Filed: Sep. 29, 2005

(51) Int. Cl. B25G 1/10

(52) U.S. Cl. 16/421

(57) ABSTRACT

The invention relates to an umbrella handle (I), which includes a handle connecting with a shaft of an umbrella. A skin layer covers around the handle and has multiple hollow projections, which is made of soft material being easily deformable. A connecting frame is provided outside the skin layer, which has a top ring and a bottom ring to loop both ends of the skin layer and to obtain a secure connection between the layer and the handle. The handle with skin layer having soft projections can be held by people with ease and comfort.

### FIELD OF THE INVENTION

The present invention relates to an umbrella handle, which includes a skin layer with multiple hollow projections to cover the rigid handle. The hollow projections is soft and can be easily compressed that makes people hold the handle more comfortably.

### BACKGROUND OF THE INVENTION

It is known that the handle of a conventional umbrella is made of hard and rigid material, such as wood, plastic, or metal. After holding the said handle of the prior umbrella for a long time, people always feel uncomfortable and painful. It is a big trouble of the prior umbrella.

### SUMMARY OF THE INVENTION

The present invention is to provide an umbrella handle (I), which includes a skin layer with multiple hollow projections to cover the handle of the umbrella. The outer surface of the handle is then soft and suitable for people to hold without disturbance. Now, accompanying with the following drawings, the character of the present invention will be described here and after.

### BRIEF DESCRIPTION OF THE DRAWINGS

FIG. 1 is a perspective view showing an umbrella handle according to the present invention.

FIG. 2 is an exploded perspective view of FIG. 1.

FIG. 3 is a top plan view of FIG. 1.

FIG. 4 is a cross-sectional view alone line 4-4 of FIG. 3.

FIG. 5 is a plan view showing an embodiment according to the present invention.

FIG. 6 is an exploded perspective view of a modified structure of the handle according to the present invention.

### DETAILED DESCRIPTION OF THE PREFERRED EMBODIMENT

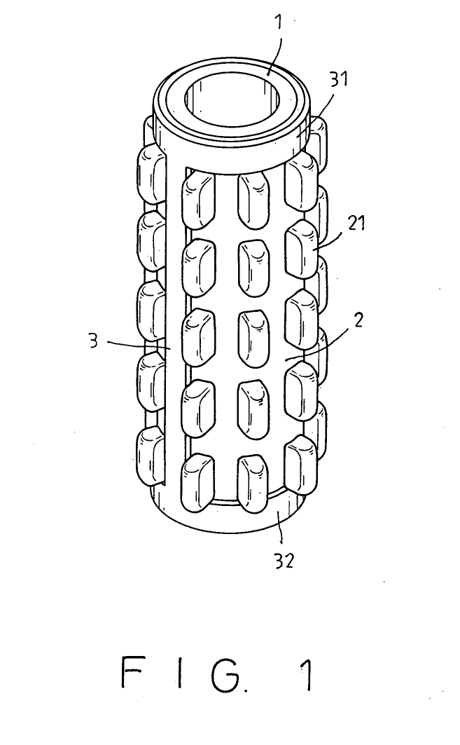

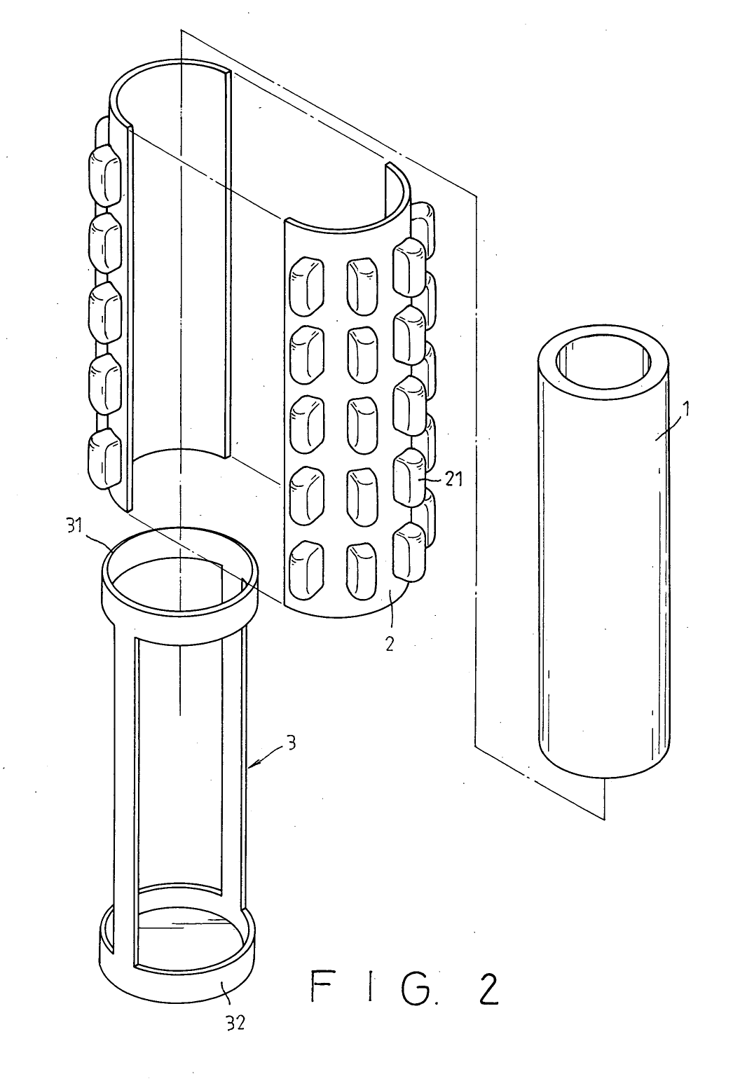

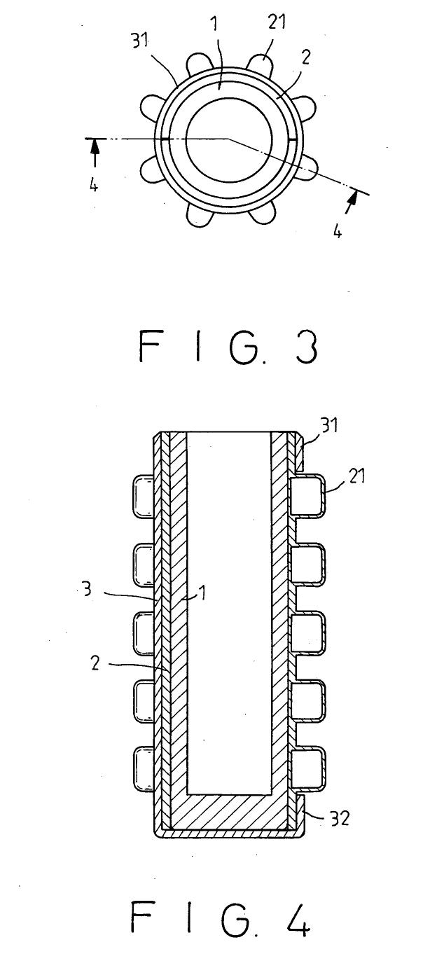

Please refer to FIG. 1 to 4; the present invention relates to an umbrella handle, which includes a rigid handle (1), a skin layer (2), and a connecting frame (3). The skin layer (2) is cover around the handle (1) and the connecting frame (3) is put outside the skin layer (2) to connect three pieces as a single one by use of its upper ring (31) and its bottom ring (32) to loop the top and bottom of the skin layer (2). The skin layer (2) is provided with many hollow projections (21), which is made of soft material with deformable character. The projections (21) will be very easy to be deformed by any slight pressure.

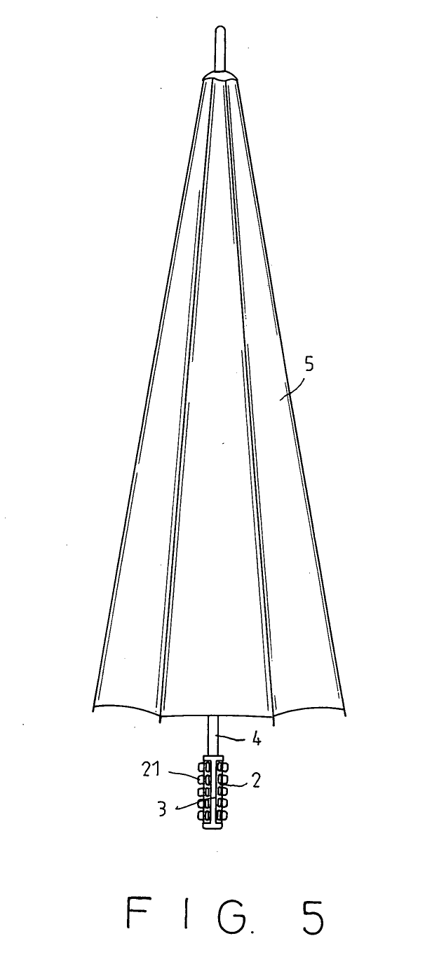

In use, the handle (1) is connected with a shaft (4) of an umbrella (5) and is covered with the skin layer (2) with multiple projections (21), as shown in FIG. 5. The umbrella handle (1) will be very soft to be held by people, who will not get tired or uncomfortable even a long time using. It is to be understood that the invented structure of the present invention obtains all conditions for allowing the patent.

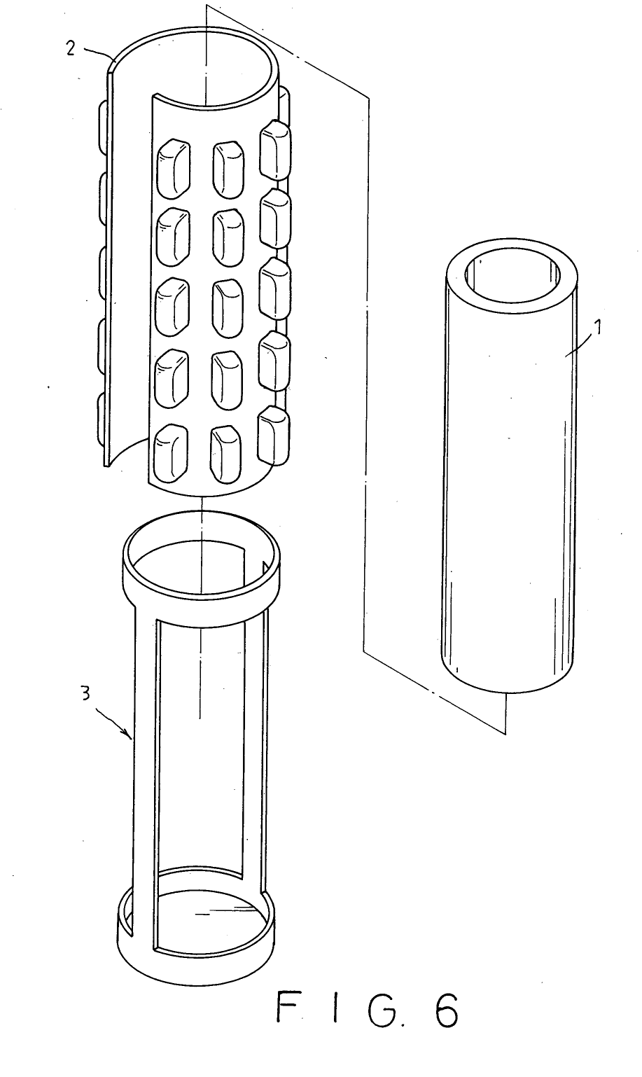

As shown in FIG. 6, the present invention includes a single skin layer instead of two pieces of former mention. It will be declared that the skin layer may include three or more pieces to cover around the handle, or the connecting frame may have its top ring and bottom ring to be a closed plane or an aperture for different applications. The handle (1) may have its top and bottom surface to be a plane or to have a hole as desire.

In above description, they are only embodiments to illustrate our embodiment and are not to limit the scope of this application. Any modified embodiments with similar merits are also claimed according to the present invention.

I claim:

1. An umbrella handle (I) including a handle connecting with a shaft of an umbrella, a skin layer covering around the handle and having multiple hollow projections made of soft material being easily deformable, and a connecting frame provided outside the skin layer having a top ring and a bottom ring to loop both ends of the skin layer and to obtain a secure connection.

2. The umbrella handle (I) as claimed in claim 1, wherein the skin layer includes one or more pieces.

3. The umbrella handle (I) as claimed in claim 1, wherein the top ring and the bottom ring may have a closed plane or an aperture.

4. The umbrella handle (I) as claimed in claim 1, wherein the handle may have its top and bottom surface to be a plane or to have a hole.
